(19) United States
(12) Patent Application Publication
(10) Pub. No.: US 2024/0116282 A1
(43) Pub. Date: Apr. 11, 2024

(54) MULTILAYER PRODUCT OF PAPER-LIKE MATERIAL, IN PARTICULAR OF CANNETÉ OR CORRUGATED CARDBOARD TYPE

(71) Applicant: GRIFAL S.P.A., Cologno al Serio (IT)

(72) Inventor: Fabio Angelo GRITTI, Cologno al Serio (IT)

(21) Appl. No.: 18/264,713

(22) PCT Filed: Feb. 8, 2022
(86) PCT No.: PCT/EP2022/053018

§ 371 Date: Aug. 8, 2023

(30) Foreign Application Priority Data
Feb. 15, 2021 (IT) 102021000003278

(51) Int. Cl. B32B 29/08; B31F 1/32; B32B 29/00; B32B 29/06; B32B 37/18

(52) U.S. Cl. CPC B32B 29/08; B31F 1/32; B32B 29/005; B32B 29/06; B32B 37/18; B31F 5/00; B32B 2250/26; B32B 2250/40; B32B 2317/127; B32B 2553/00

(57) ABSTRACT

A multilayer product made of paper-like material, includes at least one corrugated layer bonded to a first flat layer of canneté. A least one corrugated layer is constituted by a sheet of canneté which is shaped so as to form a wave. A method is also related for providing a multilayer product made of the paper-like material.

### CROSS-REFERENCE TO RELATED APPLICATIONS

This application is a 35 U.S.C. § 371 National Stage patent application of PCT/EP2022/053018, filed on 8 Feb. 2022, which claims the benefit of Italian patent application 102021000003278, filed on 15 Feb. 2021, the disclosures of which are incorporated herein by reference in their entirety.

### TECHNICAL FIELD

The present disclosure relates to a multilayer product of paper-like material, in particular of the canneté or of the corrugated cardboard type, that is particularly, but not exclusively, indicated for the provision of enclosures, containers and packaging.

### BACKGROUND

It is known that a sheet of flat paper is extremely flexible along all directions.

For some time on the market there have been products, known as “canneté”, constituted by one tensioned layer of paper-like material and one corrugated layer bonded thereto, which generally are slender and have the advantage of high rigidity in the barrel direction of the flutes and great flexibility in the direction of undulation of the flutes, to the point where they can be easily rolled up.

If the canneté is covered with another flat layer, this results in the product that is normally known by the name “corrugated cardboard”, which has good rigidity but cannot be rolled up.

Another possible conventional solution is to superimpose multiple layers levels of canneté B1, B2, B3 on each other so as to obtain a corrugated cardboard A1, A2 with several superimposed corrugations, wherein, in any case, each corrugation is formed from a single undulated flat sheet.

In the packaging sector, the need is felt to develop multilayer products of paper-like material of the corrugated cardboard or canneté type which have the best possible robustness.

As is known, the following three coefficients are normally used in measurements of robustness for this type of multilayer products made of paper-like material:
The Edge Compression Test (ECT) coefficient, which serves to determine the capacity for resistance to vertical compression of a strip of corrugated cardboard in the barrel direction of the flutes;
The Box Compression Test (BCT) coefficient, which, similarly to the previous coefficient, identifies the resistance to vertical compression of an empty box and therefore serves to correlate this value with the resistance to real-world stacking conditions that packaging materials are subjected to in a warehouse;
The Flat Compression Test (FCT) coefficient, which is an index of the resistance of a corrugated cardboard to a force applied in a direction perpendicular to the flat surface under specific conditions.

### SUMMARY

The aim of the present disclosure consists of providing a multilayer product of paper-like material, in particular of canneté or of the corrugated cardboard type, that has better mechanical characteristics and, in particular, better robustness than the background art.

Within this aim, the present disclosure provides a multilayer product of paper-like material, in particular of the canneté or of the corrugated cardboard type, that has a higher value for at least one of the ECT, BCT, and FCT coefficients than the prior art.
the disclosure relates to providing a multilayer product of paper-like material, in particular of the canneté or of the corrugated cardboard type, that is easy to implement and economically competitive.

The disclosure also includes making available a valid alternative to the prior art.

This aim and these and other advantages which will become better apparent hereinafter are achieved by providing a multilayer product according to the claims.

This aim and these and other advantages which will become better apparent hereinafter are also achieved by a method according to the claims.

### BRIEF DESCRIPTION OF THE DRAWINGS

Further characteristics and advantages of the disclosure will become better apparent from the description of some preferred, but not exclusive, embodiments of a multilayer product, which are illustrated by way of non-limiting example with the aid of the accompanying drawings wherein:

FIG. 1 is a cross-sectional view of a first multilayer product according to the prior art;

FIG. 2 is a cross-sectional view of a second multilayer product according to the prior art;

FIG. 3 is a perspective view of a first embodiment of a multilayer product according to the disclosure;

FIG. 4 is a cross-sectional view of the multilayer product of FIG. 3;

FIG. 5 is a cross-sectional view of a second possible embodiment of the multilayer product according to the disclosure;

FIG. 6 is a cross-sectional view of a third possible embodiment of the multilayer product according to the disclosure; and

FIG. 7 is a cross-sectional view of a fourth possible embodiment of the multilayer product according to the disclosure.

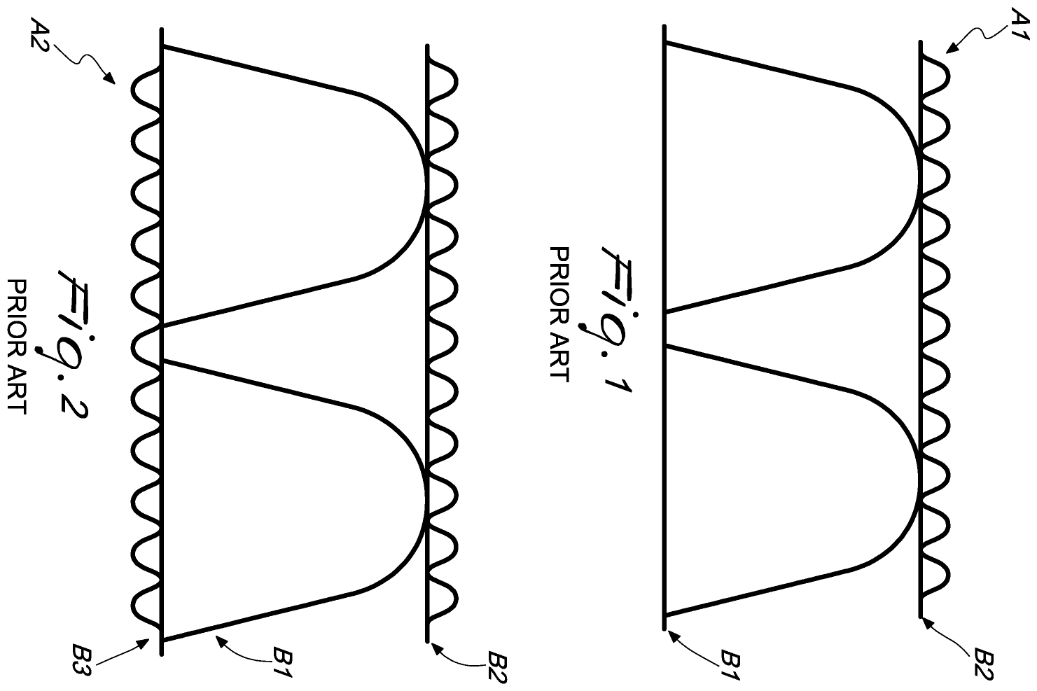

### DETAILED DESCRIPTION OF THE DRAWINGS

With reference to the figures, the multilayer product of paper-like material, generally designated by the reference numeral 1, 10, 100 or 1000 according to the embodiment, is “of paper-like material”, i.e. its main components (i.e. the sheets or layers of which is composed, which will be described below) are mainly made of paper-like material, which does not rule out the presence within it of other, complementary materials, such as for example adhesives or plastic materials.

The term “paper-like material” means any type of paper or cardboard made available by the state of the art.

In particular, the multilayer product 1, 10, 100 to which reference is made can be considered, according to the embodiments, to be of the canneté or of the corrugated cardboard type, and is therefore particularly adapted for providing packaging, boxes and similar applications.

Similarly to the prior art referred to, the multilayer product 1, 10, 100, 1000 can be made of panels or sheets of any extension. In some embodiments, like the one shown in FIG. 5, the multilayer product 1 can be stored in rolls.

The multilayer product 1, 10, 100, 1000 comprises at least one corrugated layer 3, 3′ bonded to (i.e. fixed, preferably glued or heat-welded) to a first flat layer of canneté 2, 2′.

According to the disclosure, such at least one corrugated layer 3, 3′ is constituted in turn by a sheet of canneté which is shaped so as to form a wave (i.e. it has been fully undulated).

Therefore, the corrugated layer 3, 3′, does not consist of a single undulated flat sheet as in the background art, but of a sheet of canneté which has been shaped so as to form a wave.

As will be described below, this corrugated layer 3, 3′ is in practice obtained starting from a conventional sheet of canneté, which is undulated by shaping it so as to form a wave.

The Applicant has in fact experimentally discovered that by making the corrugated layer with material that is in turn corrugated, the mechanical characteristics of the multilayer product significantly improve.

As is known, a sheet of canneté is a sheet constituted by a tensioned layer of paper-like material and a corrugated layer bonded thereto.

Therefore, the sheet of canneté that constitutes the corrugated layer 3, 3′ and which is shaped so as to form a wave, comprises in turn a corrugated sheet 32 fixed to the surface of a tensioned sheet 31 which is in turn shaped so as to form a wave, and therefore the corrugated sheet 32 extends along a wave; it is to be noted that the amplitude and the wavelength of the wave of the tensioned sheet 31 are greater than the amplitude and the wavelength of the corrugated sheet 32.

All the corrugated layers 3, 3′ to which reference will be made from this point onward, and in the accompanying claims, have the above characteristics deriving from the fact that they are constituted by a sheet of canneté which has been shaped so as to form a wave.

In some embodiments, such as the one shown in FIG. 5, there is a single corrugated layer 3 bonded to a single flat layer of canneté 2 and therefore the corrugated layer 3 is free on one of its two faces, and therefore, similarly to sheets of conventional canneté, the multilayer product 1 can be rolled up and therefore this embodiment can be likened, functionally, to canneté.

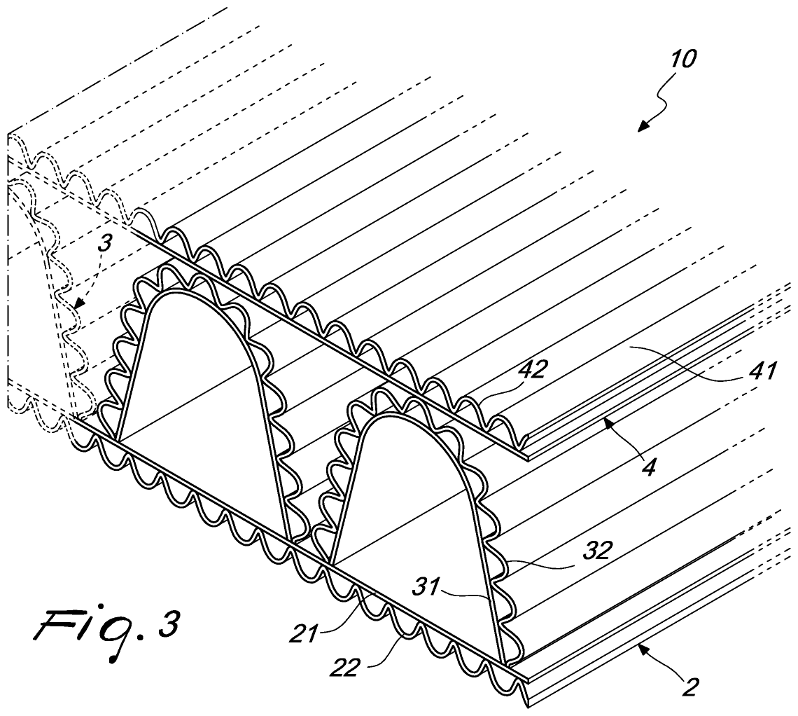

In other embodiments, like those illustrated in FIGS. 3, 4, 6 and 7, the at least one corrugated layer 3, 3′ is comprised between a first flat layer of canneté 2 and a second flat layer of canneté 4, 4′.

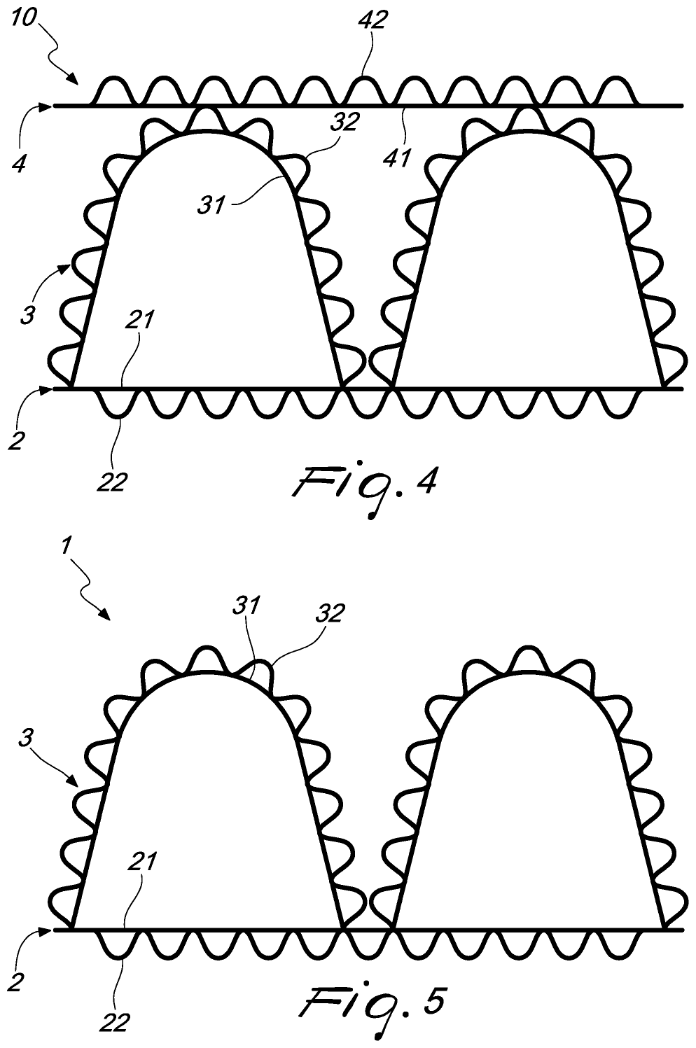

In practice, when a second flat layer of canneté 4 is added to the embodiment shown in FIG. 5 by fixing it to the other side of the corrugated layer 3 opposite from the first flat layer 2, a multilayer product 10 in the embodiment of FIGS. 3 and 4 is obtained.

The multilayer product 10, 100 of the embodiments illustrated in FIGS. 3, 4 and 6, which comprise a single corrugated layer 3 comprised between two flat layers 2, 4 of canneté, can be functionally likened to corrugated cardboard with a single corrugated layer.

Note that in these embodiments, the corrugated layer 3 (constituted by a sheet of canneté) is fixed directly to the first flat layer of canneté 2 and to the second flat layer of canneté 4.

In yet other embodiments, such as for example that of FIG. 7, the multilayer product 1000 comprises two or more superimposed corrugated layers 3, 3′ which are preferably comprised between a first 2 and a second 4′ flat layer of canneté.

Even more preferably, an intermediate flat layer of canneté 2′ is interposed between the above mentioned two superimposed corrugated layers 3, 3′.

In more detail, in the embodiment shown in FIG. 7, the multilayer product 1000 comprises, in this order:
a first flat layer of canneté 2;
a first corrugated layer 3 fixed to the first flat layer of canneté 2;
an intermediate flat layer of canneté 2′ fixed to the first corrugated layer 3;
a second corrugated layer 3′ fixed to the intermediate flat layer of canneté 2′;
a second flat layer of canneté 4′ fixed to the second corrugated layer 3′.

As previously clarified, each one of the above mentioned corrugated layers 3, 3′ is constituted by a sheet of canneté which is shaped so as to form a wave.

In practice, by superimposing two multilayer products 1, 10, 100 which comprise a single corrugated layer 3 (like those of FIGS. 3-6) on each other and fixing them to each other, a multilayer product 1000 is obtained with two corrugated layers such as for example that of FIG. 7.

Obviously other embodiments are also possible in which, in a manner that is obvious in light of the foregoing description, further corrugated layers and/or further flat layers of canneté are superimposed.

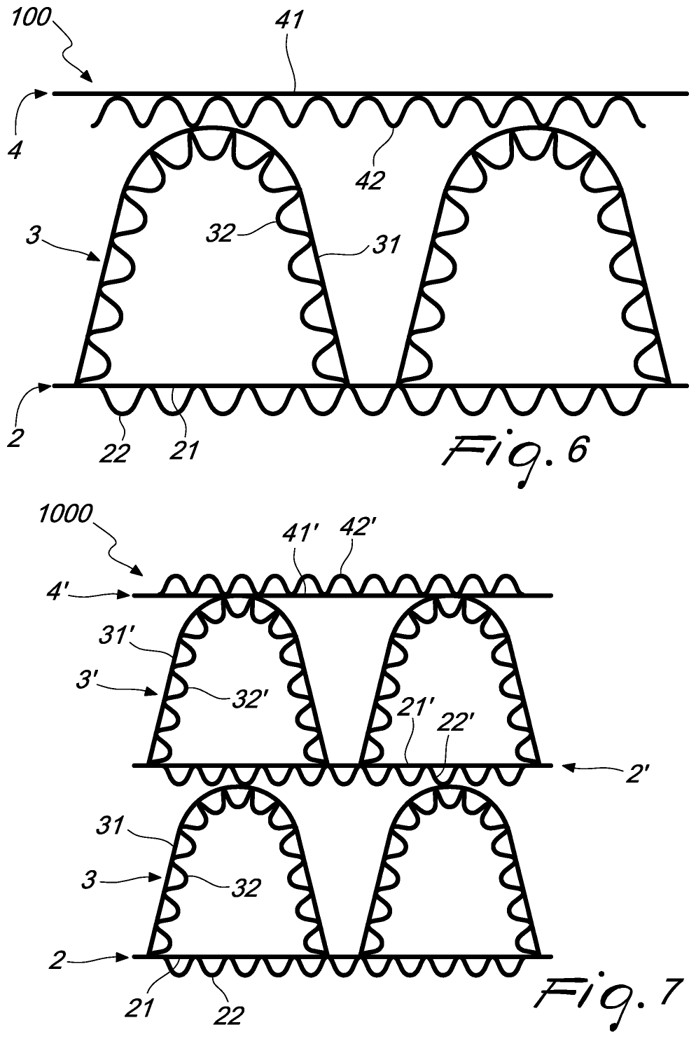

In any embodiment, the corrugated layer 3, 3′ can present the corrugations of the corrugated sheet 32 protruding toward the inside (as in FIG. 6) or toward the outside (as in FIGS. 4 and 5) of the large wave formed by the tensioned sheet 31, according to the implementation choices.

In practice, in some embodiments (as in FIGS. 4 and 5), in the corrugated layer 3, the corrugated sheet 32 is fixed to an external surface of the tensioned sheet 31 so as to protrude toward the outside of the wave formed by the tensioned sheet 31; in this case the second flat layer of canneté 4, 4′ is fixed to the corrugated sheet 32 (to the crests of the wave thereof).

In other embodiments (as in FIG. 6), in the corrugated layer 3, the corrugated sheet 32 is fixed to an internal surface of the tensioned sheet 31 so as to protrude toward the inside of the wave formed by the tensioned sheet 31; in this case the second flat layer of canneté 4, is fixed to the tensioned sheet 31 (to the crests of the wave thereof).

In a multilayer product 1000 with multiple superimposed corrugated layers 3, 3′, a first corrugated layer 3 can present the corrugations of the corrugated sheet 32 protruding toward the inside and a second corrugated layer 3′ can present the corrugations of the corrugated sheet 32′ protruding toward the outside.

The multilayer product 1, 10, 100, 100 can be easily produced by way of a method that comprises the following steps:
a) supplying two or more flat sheets of canneté;
b) undulating at least one of the flat sheets of canneté so as to obtain a sheet of canneté shaped so as to form a wave; this shaping of the flat sheets of canneté can for example be obtained by way of a corrugation process and an apparatus as described in EP16705439;
c) fixing the sheet of canneté shaped so as to form a wave to a first flat sheet of canneté.

After these steps, a corrugated layer 3 is obtained which is constituted by the sheet of canneté shaped so as to form a wave, bonded to a first flat layer of canneté 2 constituted by the first flat sheet of canneté, and therefore a multilayer product 1 is obtained like that of FIG. 5.

Optionally, the following further step can be performed:
d) fixing a second flat sheet of canneté to the above mentioned corrugated layer 3 so as to form a second flat layer of canneté 4.

In this manner the corrugated layer 3 is comprised between the first 2 and second 4 flat layer of canneté, thus obtaining a multilayer product like that of FIGS. 3, 4, 6.

The steps just described can be repeated in order to superimpose more layers.

In order to obtain advantageously a multilayer product 1000 with two or more corrugated layers, such as for example that of FIG. 7, the following step can be executed:
e) superimposing and mutually bonding two or more multilayer products 1, 10, 100, each one of which is obtained by way of the steps a), b)
c) and optionally d).

Preferably all the sheets and the layers are paper.

The operation and use of the multilayer product 1, 10, 100, 1000 according to the disclosure is entirely similar to that of conventional multilayer products of the canneté or corrugated cardboard type.

Advantageously, the present disclosure has values of the ECT, BCT, FCT coefficients indicating robustness which are significantly higher than the prior art.

By way of example, it is possible to provide a multilayer product according to the disclosure, like that of FIG. 4, with thin paper of 40-50 g/sq·m, which has mechanical characteristics in terms of robustness that are similar to those that a traditional product made with paper of much greater thickness, of approximately 600 g/sq·m, would (theoretically) have, which—in the state of the art—is not technically possible in that today it cannot be corrugated according to the prior art.

In practice it has been found that the multilayer product according to the present disclosure achieves the intended aim and objects in that it has a better robustness than the background art, and in particular higher values for the ECT, BCT, FCT coefficients.

Another advantage of the multilayer product according to the disclosure consists in that it is easy to implement and economically competitive.

Another advantage of the multilayer product according to the disclosure consists in that it makes available a valid alternative to the prior art.

The multilayer product, thus conceived, is susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

1-11. (canceled)

12. A multilayer product made of paper material, comprising at least one corrugated layer bonded to a first flat layer of canneté,
wherein said at least one corrugated layer is constituted by a sheet of canneté which is shaped so as to form a wave.

13. The multilayer product according to claim 12, wherein said at least one corrugated layer is comprised between a first flat layer of canneté and a second flat layer of canneté.

14. The multilayer product according to claim 13, wherein said corrugated layer constituted by a sheet of canneté is fixed directly to said first flat layer of canneté and to said second flat layer of canneté.

15. The multilayer product according to claim 12, wherein said at least one corrugated layer constituted by a sheet of canneté in turn comprises a corrugated sheet which is fixed to a surface of a tensioned sheet, said tensioned sheet being in turn shaped so as to form a wave.

16. The multilayer product according to claim 15, wherein said corrugated sheet is fixed to an external surface of the tensioned sheet so as to protrude toward the outside of the wave formed by the tensioned sheet.

17. The multilayer product according to claim 15, wherein said corrugated sheet is fixed to an internal surface of the tensioned sheet so as to protrude toward the inside of the wave formed by the tensioned sheet.

18. The multilayer product according to claim 12, further comprising two or more superimposed corrugated layers.

19. The multilayer product according to claim 18, further comprising, in this order:
said first flat layer of canneté;
a first corrugated layer which is fixed to said first flat layer of canneté;
an intermediate flat layer of canneté which is fixed to said first corrugated layer;
a second corrugated layer which is fixed to said intermediate flat layer of canneté; and
a second flat layer of canneté which is fixed to said second corrugated layer;
wherein each one of said corrugated layers is constituted by a sheet of canneté which is shaped so as to form a wave.

20. A method for providing a multilayer product made of paper material, the method including the following steps:
a) supplying one or more flat sheets of canneté,
b) undulating at least one of said flat sheets of canneté so as to obtain a sheet of canneté shaped so as to form a wave, and
c) fixing said sheet of canneté shaped so as to form a wave to a first flat sheet of canneté,
so as to obtain a corrugated layer constituted by said sheet of canneté shaped so as to form a wave bonded to a first flat layer of canneté constituted by said first flat sheet of canneté.

21. The method according to claim 20, further including the step of:
d) fixing a second flat sheet of canneté to said corrugated layer so as to form a second flat layer of canneté,
so that said corrugated layer is comprised between said first flat layer of canneté and said second flat layer of canneté.

22. A method for providing a multilayer product made of paper material, including the step of:
e) superimposing and mutually bonding two or more multilayer products, each one of which is obtained by way of the method according to claim 20.
